(19) United States
(12) Patent Application Publication
(10) Pub. No.: US 2008/0244682 A1
(43) Pub. Date: Oct. 2, 2008

(54) METHOD FOR ENHANCING FEATURES OFFERED BY A SOFTWARE APPLICATION RESIDING ON A SET TOP TERMINAL

(75) Inventors: Carlton J. Sparrell, Marblehead, MA (US); Gordon S. Landis, Stow, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/055,028

(22) Filed: Mar. 25, 2008

Related U.S. Application Data
(60) Provisional application No. 60/908,064, filed on Mar. 26, 2007.

(51) Int. Cl. H04N 7/173

(52) U.S. Cl. 725/134

(57) ABSTRACT

A set top terminal includes a processor and a runtime execution engine adapted to run on the processor. The runtime execution engine has at least one interface to expose one or more functions of the runtime execution engine. The set top terminal also includes a software application adapted to run on the runtime execution engine. An application interface shim is also provided to chain calls between the software application and the runtime execution engine and to redirect select functions calls over a communications network to a remote device. The select function calls enable at least one feature not otherwise available to the software application.

### RELATED APPLICATION SECTION

This application claims the benefit of U.S. Provisional Patent Application Ser. No. 60/908,064, filed Mar. 26, 2007, entitled “Method for Enhancing Features Offered by a Software Application Residing on a Set Top Terminal”, which is incorporated by reference herein in its entirety.

### FIELD OF THE INVENTION

The present invention relates to set top terminals and more particularly to the operation of software applications that reside on an OpenCable Application Platform (OCAP) compliant or other standardized set top terminal platform.

### BACKGROUND OF THE INVENTION

With the increasing use of digital devices for storing media content, a home or business environment will often have a number of different storage devices that a user would like to access, together with a number of different devices that can be used to view, listen to or otherwise render stored media content. For example, homes now include digital equipment that enable residents to watch television and surf the Internet at the same time on the same digital device, to view digital photographs and video on the television or on the computer, to network personal computers, set top terminals and other devices within the home to enable the sharing of documents, images, video, audio and other types of media. It is desirable to network these together so that a user can, for example, record a program on a digital video recorder (DVR) in one room and concurrently or subsequently view it on a television connected to a set top terminal in another room.

When watching a video program, slide show presentation or the like, or when playing a video game, the user may wish to move the viewing session from one location in the home to another. This can be a particularly useful feature when combined with common DVR functions such as pause and play. For example, a user may wish to pause a program such as a movie in the living room and then resume watching it in the kitchen. Similarly, a user may wish to start recording a program on a DVR in the family room and then move it so that it can be viewed through another set top terminal.

Currently, remote rendering, in which content is rendered with a set top terminal other than the one where the content is stored or received, can be a cumbersome process if it is possible at all. Typically, even when possible, vendor-proprietary implementations are generally employed. Various standards have been proposed, however, to overcome these problems. For instance, the OpenCable Application Platform (OCAP) specification is a middleware software layer specification intended to enable the developers of interactive television services and applications to design such products so that they will run successfully on any cable television system, independent of set-top or television receiver hardware or operating system software choices. As is well known, middleware generally comprises one or more layers of software which are positioned “between” application programs and the lower or physical layers of the network device. A key role of middleware is to insulate the application programs from the device specific details. By using middleware the application programmers need know very little about the actual network details, since they can rely on the middleware to address the complexities of interfacing with the network.

Recently, an extension to OCAP, referred to as the OCAP Home Networking (HN) Extension has become available. OCAP HN provides for the discovery and sharing of content among OCAP-compliant devices that are capable of storing, receiving or transferring content over a home network such as a local area network (LAN). The OCAP HN Extension provides this functionality through a set of API's that provide services such as discovering devices connected to the home network, discovering content stored on the connected devices, organizing and presenting to a user information about the content stored on the connected devices, and directing content on one connected device to be transferred and rendered on another connected device. OCAP and OCAP HN operate in a Java environment in which a Java program or application is executed by a Java Virtual Machine (JVM) that is accessed through Java APIs.

Unfortunately, many television services and applications that have been developed to operate in an OCAP environment have not been designed to take advantage of the features that are available when operating in a networked environment such as an OCAP HN environment. For instance, many currently available DVR applications do not support remote rendering features. While application developers could design new applications or revise old applications to take advantage of home networking APIs such as those offered in the OCAP HN specification, it would be preferable to add the enhanced functionality without modifying the core parts of the application itself. There are various reasons for this, including, most notably, the considerable investment in time and money that have already been expended in developing the stand-alone programs. In addition, it may not be prudent to change the code due to scheduling pressures or reliability concerns.

### BRIEF DESCRIPTION OF THE DRAWINGS

FIG. 1 shows one example of a home entertainment network in which one or more set top terminals may be incorporated.

FIG. 2 shows a generalized computer architecture of a set top terminal platform that is defined in terms of hardware and software.

FIG. 3 shows the logical architecture of one particular example of the set top terminal platform shown in FIG. 2 and which conforms to the OCAP software specification architecture.

FIG. 4 is a block diagram illustrating one example of a DVR API shim.

FIG. 5 also shows an example of the signaling interactions that arise between the two set top terminals when a user of the non-DVR enabled set top terminal wishes to render a particular program recorded on the DVR of set top terminal.

FIGS. 6 and 7 shows an of the signaling interactions that arise between the two set top terminals when a user performs a so-called shadow recording, first by tuning a program (FIG. 6) and then pausing the program (FIG. 7).

### DETAILED DESCRIPTION

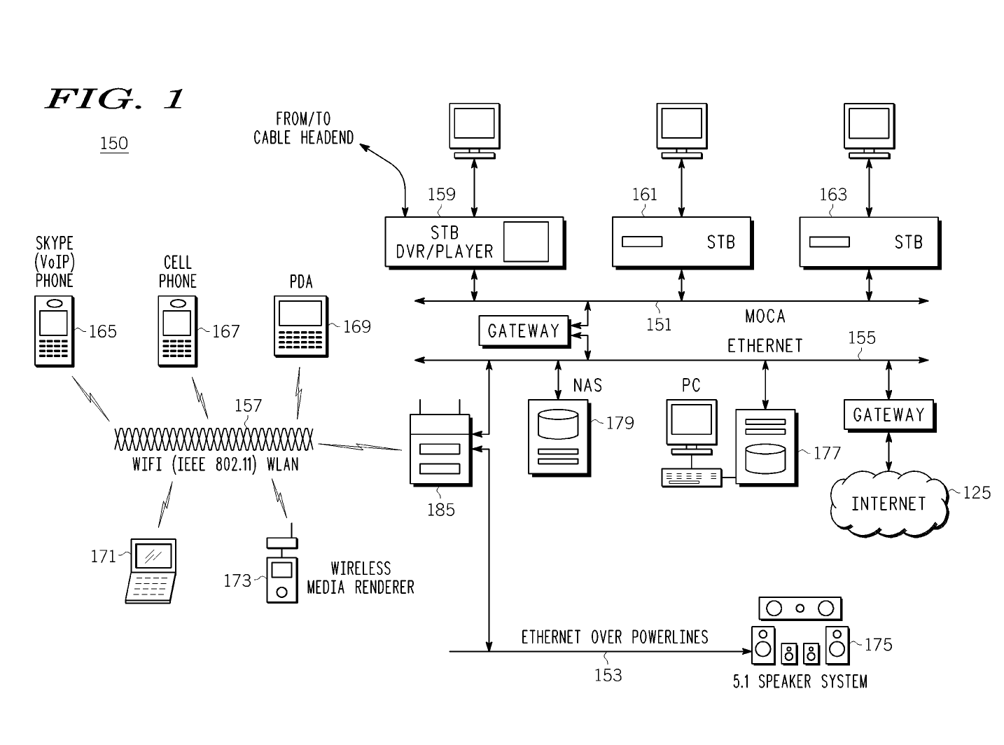

FIG. 1 shows one example of a home entertainment network 150 in which one or more set top terminals may be incorporated. Coupled to the network 150 are various storage/retrieval/input/playback devices that are typically located in different rooms of the house. The network 150 in this example is a network of networks and includes a Media over Coax (MOCA) network 151, an Ethernet over powerlines network 153, a wired local area network, e.g., an Ethernet 155, and a wireless network (wireless local area network, WLAN) 157, e.g., a Wi-Fi network that conforms to the IEEE 802.11 standard. The network 150 also includes a connection to another network, e.g., the Internet 125.

One device that communicates over network 150 is a DVR-equipped set top terminal 159 that is coupled via cable to a cable headend, and also coupled to the MOCA network 151. The set top terminal 159 is capable of playback and is also the source of AV content. Also coupled to the MOCA network are set top terminals 161 and 163, neither of which include a DVR.

Coupled to the Ethernet 155 is a network attached storage device (NAS) 179 on which media content is stored and a personal computer (PC) 177. The Ethernet 155 is also coupled to the Internet 125 and to the Ethernet over powerlines network 153. A speaker system 175 is coupled to the Ethernet over powerlines network 153.

Several devices are shown coupled to the wireless network 157. A laptop PC 171 and a wireless portable media player 173, e.g., a wireless MP3 and video player 173, are operable to be coupled to the WLAN. Also connectable to the wireless network 157 are portable devices such as a voice-over-IP (VoIP) phone 165 and a mobile cellular phone 167 that includes a wireless network interface to connect to the wireless network 157. In some cases the phones 165 and 167 may also include components that are operable to store and play back content. A personal digital assistant (PDA) 169 is also coupled to wireless network 157. Wireless network 157 communicates with wired local area network 155 over wireless access point 185.

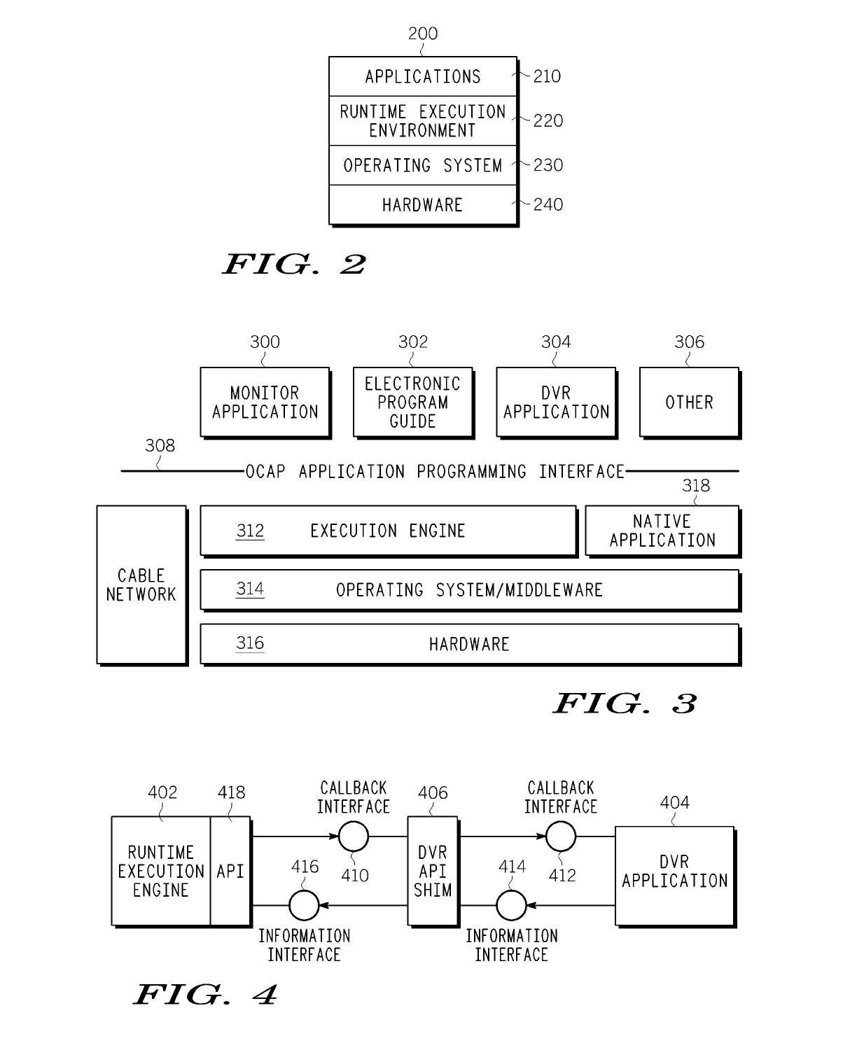

FIG. 2 shows a generalized computer architecture of a set top terminal platform 200 that is defined in terms of hardware and software. The platform 200 includes an application layer 210 that may include a variety of different software applications such as an Electronic Program Guide (EPG) application, a Video on Demand (VOD) application, and a Digital Video Recorder (DVR) application. Other applications that may be included can be directed to games, shopping, e-commerce, news, and other interactive television functions and services. These applications are run on top of a runtime execution environment or engine 220, which in turn runs on top of the Operating System (OS) 230 that controls the hardware 240. The hardware 240 includes such well known components as processors, tuners, decoders, storage devices and the like.

The runtime execution environment or engine 220 that resides between the OS 230 and the applications 210 serves as a space in which the application 210 may execute specific tasks on the set top terminal 200. The runtime execution environment 220 may serve as a programming and/or an execution platform. As a programming platform, the runtime execution environment may compile one or more applications, which may be written in one of multiple computing languages, into an intermediate language (IL) or bytecode. As an execution platform, the runtime execution environment may interpret compiled IL into native machine instructions. A runtime execution environment may utilize either an interpreter or a compiler to execute such instructions. Regardless, the native machine instructions may then be directly executed by the hardware. Since IL is hardware-independent, IL may execute on any hardware platform as long as the OS running on that platform hosts an appropriate runtime execution environment. Alternatively, the applications may be precompiled and loaded as one or more native image files in the runtime execution environment, thus circumventing the hardware consumption required for compilation.

Common examples of runtime execution environments 220 that may be employed include: Visual Basic runtime environment; Java Virtual Machine runtime environment that is used to run, e.g., Java routines; and Common Language Runtime (CLR) to compile, e.g., Microsoft .NET applications into machine language before executing a calling routine.

The runtime execution environment includes a series of interfaces such as application program interfaces (APIs), which provide the application developer a common access point through a programming language to communicate with the underlying platform or to provide access to proprietary features. APIs can be used to invoke services to generate and control graphics or sound and perform any number of other services or functions. For instance, in the context of a set top terminal, a set of DVR APIs may be used to schedule and manage recordings by enabling such features as record, play, rewind, and the like. If the runtime execution environment is network-enabled, the DVR APIs may also be used to invoke functions that enable such features as scheduling a recording on, or playing a recording from, a remote DVR device.

By using the computer architecture shown in FIG. 2, a single application can run on many different systems because the runtime execution environment abstracts the underlying details. As a result application developers do not need to write and deploy multiple applications to operate on multiple platforms, which is time-consuming, burdensome and costly.

FIG. 3 shows the logical architecture of one particular example of the set top terminal platform shown in FIG. 2 and which conforms to the OCAP software specification architecture. While this architecture will be used for purposes of illustration, the methods, techniques, modules and systems described herein are equally applicable to other architectures that may be employed on a set top terminal. For instance, examples of such architectures are defined in standards such as ATVEF's (Advanced Television Enhancement Forum) Enhanced Content Specification, ATSC's (Advanced Television Systems Committee) DASE (Digital television Applications Software Environment) specification, and DVB's (Digital Video Broadcasting) MHP (Multimedia Home Platform) specification.

Referring to FIG. 3, the top of an OCAP software “stack” includes a Monitor Application 300, Electronic Program Guide (EPG) 302, Digital Video Recorder (DVR) application 304, and any other applications 306 that may be deployed in a particular network. These applications are run on top of a Java virtual machine software layer 312 and interface to the Java virtual machine using the well known OCAP APIs 308. The platform 200 may also include certain software applications or “Native Applications” 318 that do not run within the Java virtual machine, but directly run on top of the Operating System 314 for the client device. Native Applications are typically written for a particular hardware configuration 316 of the platform 200

Examples of such Native Applications may include management of front panel functionality, remote control interaction, games, and the like.

As previously mentioned, many applications operable on a set top terminal platform have been designed to operate on terminals that are not network-enabled and thus do not communicate with one another over home networks such as the home network shown in FIG. 1. In order to add an additional feature or feature set to an application without changing the code of the application, an application API shim may be used. The application shim is inserted between the application and the application program interface (API) in the runtime execution environment. The application shim intercepts communications between the application and the APIs. Calls from and to the application are chained through the application shim. For example, a DVR application shim may be used to read and write API calls to and from a non-network enabled DRV application, which can be used, for instance, to enable such features as remote rendering or remote recording.

For purposes of illustration only, the following description will refer to a DVR application. However, more generally, the methods, techniques, modules and systems described herein are equally applicable to other applications that may be employed on a set top terminal.

Referring to FIG. 4, a DVR application program interface (API) 418 exposes one or more functions of the runtime execution engine 402 to the DVR application 404. In the context of the example implementations described herein, the DVR API may be regarded as a language and message format provided by the runtime execution environment to enable DVR application 404 to communicate with the functionality in the runtime execution environment 402. The DVR API includes a callback interface 412 by which the runtime execution environment 402 notifies the DVR application 404 of events and an information interface 416 by which the DVR application 404 requests information from the runtime execution environment 402, typically in response to a callback.

DVR API shim 406 includes a callback interface 410 and an information interface 414. When the runtime execution environment 402 calls a function on the DVR application's callback interface 410, the DVR application shim 406 chains the call through to the DVR application 404. When the DVR application 404 calls a function on the DVR API shim's information interface 414, the shim 406 chains the call to the runtime execution environment 402. Before or after chaining a call, the DVR API shim 406 may perform one or more actions. Since the DVR API shim 406 may be inserted as desired, the shim 406 may add functionality without changing the code of the DVR application 404.

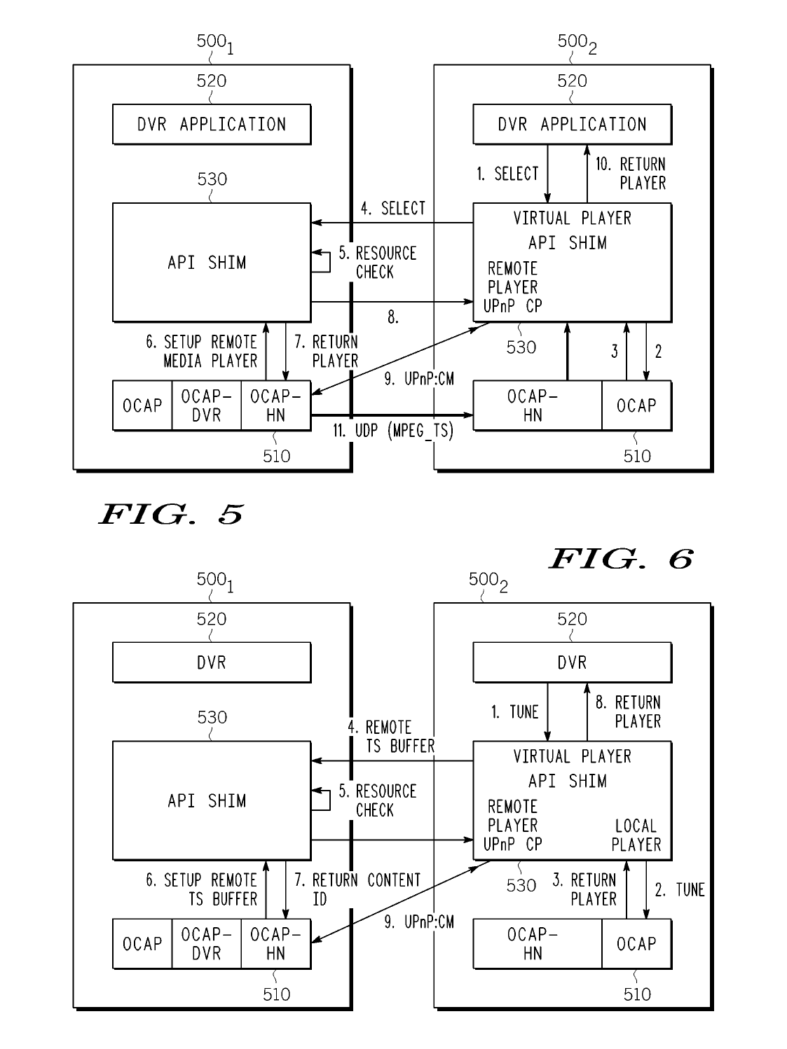

FIG. 5 shows one example of how a DVR API shim 530 may operate on set top terminals 500₁ and 500₂ that are in communication with one another over a home network. In this example both set top terminals 500₁ and 500₂ are OCAP HN compliant. Set top terminal 500₁ includes a DVR and set top terminal 500₂ does not. Accordingly, set top terminal 500₁ includes OCAP DVR APIs in its API layer 510 while set top terminal 500₂ does not include such OCAP DVR APIs. A common DVR application 520 resides on both set top terminals 500₁ and 500₂. The DVR application 520 does not include any networking capability such as remote rendering or recording. API shim 530 reads and writes API calls to and from the DVR application 520 and the API layer 510. For simplicity, underlying layers such as the OCAP execution engine, the OS and the hardware are omitted from FIG. 5.

FIG. 5 also shows an example of the signaling interactions that arise between the two set top terminals 500₁ and 500₂ when a user of the non-DVR enabled set top terminal 500₂ wishes to render a particular program recorded on the DVR of set top terminal 500₁. It should be emphasized that as noted above, while set top terminal 500₂ does not include the necessary hardware (e.g., a hard drive or the like) or middleware to perform DVR functions, it has been loaded with DVR software application 520. The signaling is shown as a series of function or API calls. Since the terminals 500₁ and 500₂ are OCAP HN compliant, the particular calls are Java API calls. Of course, as previously noted, in other implementations that employ different runtime execution environments, different types of API calls will be used.

When a user of terminal 500₂ first selects (via a user interface associated with DVR application 520) a recorded program on remote terminal 500₁ for rendering with terminal 500₂, terminal 500₂ invokes a select call to API shim 530. The select call at 1 requests the platform to create the resources and the pipeline necessary to play the selected content and to return to the DVR application 520 a software object such as a java media framework player that can be used to control the content. The API shim 530, in turn, at 2 chains the call through to the OCAP APIs in API layer 510. At 3 the local resources such as the decoder and the home networking functions are activated and returned to the API shim 530. Since the content resides on the remote terminal 500₁, at 4 a version of the select call is redirected from its original code path back to the DVR application 520 to a different code path over the home network, where it is received by the API shim 530 on terminal 500₁. In response to the call, the remote terminal 500₁ performs a network resource check at 5 to ensure that the resources of the home network such as bandwidth are available to support the streaming content. At 6, the API shim 520 in player 500₁ sends a setup call to the OCAP HN APIs in API layer 510. The setup call requests a remote media player (i.e., a java media framework player) to stream the selected content. The remote media player includes the mechanism needed to control the manner in which the streaming content will be rendered in any selected rendering state such as play, pause, rewind and fast forward. The remote media player is returned to the API shim 530 at 7 and redirected over the home network to the API shim 530 in terminal 500₂ at 8. A Universal Plug and Play (UPnP) control point is established at 9 between the API layer 510 of terminal 5001 and the API shim 530 of terminal 500₂. The control point provides an interface for controlling the remote media player. At 10, the API shim 530 in terminal 500₂ returns the remote media player to the DVR application 520. In this way the DVR application 520 in terminal 500₂ can be used to control the presentation of the selected content using the remote media player. Finally, at 11, the content is streamed from terminal 500₁ to terminal 500₂ over the home network using an appropriate transport layer protocol such UDP or TCP, for example.

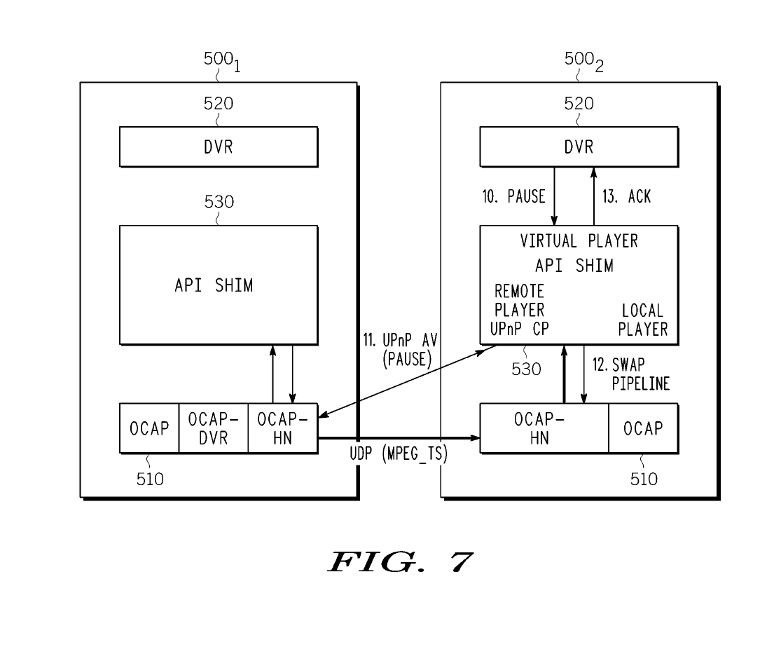

FIGS. 6 and 7 shows another example of the signaling interactions that arise between the two set top terminals 500₁ and 500₂ when a user performs a so-called shadow recording. In this example the user is viewing a program that is being received in live time on the local set top terminal 500₂. That is, the local set top terminal 500₂ is tuned to a channel on which a program is being delivered over a broadband network. At the same time, the program is being recorded on the remote set top terminal 500₁. If the user pauses the program on the local set top terminal 500₂, the paused program will be rendered using the DVR on the remote set top terminal 500₁. In other words, when the user pauses the live program, the set top terminal 500₂ will request delivery of the paused content from the remote set top terminal 500₁ over the home network.

The processes described above may be implemented in a general, multi-purpose or single purpose processor. Such a processor will execute instructions, either at the assembly, compiled or machine-level, to perform that process. Those instructions can be written by one of ordinary skill in the art following the descriptions herein and stored or transmitted on a computer readable medium. The instructions may also be created using source code or any other known computer-aided design tool. A computer readable medium may be any medium capable of carrying those instructions and includes a CD-ROM, DVD, magnetic or other optical disc, tape, silicon memory (e.g., removable, non-removable, volatile or non-volatile), packetized or non-packetized wireline or wireless transmission signals.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A set top terminal, comprising:
a processor;
a runtime execution engine adapted to run on the processor, the runtime execution engine having at least one interface to expose one or more functions of the runtime execution engine;
a software application adapted to run on the runtime execution engine; and
an application interface shim to chain calls between the software application and the runtime execution engine and redirect select functions calls over a communications network to a remote device, wherein the select function calls enable at least one feature not otherwise available to the software application.

2. The set top terminal of claim 1 wherein the software application is a DVR application.

3. The set top terminal of claim 2 wherein the remote device includes a DVR and the at least one feature enabled by the select function calls includes remote rendering.

4. The set top terminal of claim 2 wherein the remote device includes a remote set top terminal and the at least one feature enabled by the select function calls includes remote rendering and remote recording.

5. The set top terminal of claim 1 wherein the application interface shim is adapted to return a java media framework player from the remote device to the software application in response to a select call from the software application.

6. The set top terminal of claim 1 wherein the runtime execution engine is OCAP HN compliant.

7. The set top terminal of claim 1 wherein the runtime execution engine includes a Java virtual machine.

8. The set top terminal of claim 1 wherein the interface exposing the runtime execution engine is an application program interface (API) and the calls chained between the software application and the runtime execution engine are API calls.

9. The set top terminal of claim 1 wherein the software application is adapted to call non-networking APIs associated with the runtime execution engine and not networking APIs associated with the runtime execution engine.

10. The set top terminal of claim 1 wherein the at least one feature enabled by the select function calls includes network-enabled features.

11. A computer-readable storage medium containing instructions which, when performed by one or more processors disposed in an electronic device, performs a method comprising:
receiving a function call from a non-network enabled software application to render in a selected rendering state content available on a remotely located device;
re-directing the function call along a code path over a communications network to an execution engine residing on the remotely located device; and
in response to the re-directed function call, receiving the selected content in the selected rendering state.

12. The computer-readable medium of claim 11 further comprising receiving over the code path a media player through which the content is rendered in the selected rendering state.

13. The computer-readable medium of claim 11 wherein the selected rendering state is selected from the group consisting of pause, play, rewind and fast-forward.

14. The computer-readable medium of claim 11 wherein the function call is an API call.

15. The computer-readable medium of claim 11 wherein the software application is a DVR application and the remotely located device includes a DVR.

16. A method of enhancing features offered by a software application operable on a network-enabled set top terminal, comprising:
installing the software application on the network-enabled set top terminal, the set top terminal having a software stack that includes an execution engine; and
providing an API shim between the software application and the execution engine, wherein the API shim is configured to redirect select API calls to an external resource capable of performing functions of which the execution engine is incapable and which enable at least one enhanced feature accessible to a user through the software application.

17. The method of claim 16 wherein the API shim is further configured to receive a software object from the external resource and forward the software object to the software application so that the enhanced feature can be enabled.

18. The method of claim 17 wherein the software object is a media player.

19. The method of claim 16 wherein the software stack is an OCAP software stack having OCAP HN extensions.
